(19) United States
(12) Patent Application Publication
(10) Pub. No.: US 2025/0282310 A1
(43) Pub. Date: Sep. 11, 2025

(54) Fastening Apparatus for Fastening a First Component to a Second Component, as well as a Method for Assembling Such a Fastening Apparatus

(71) Applicant: Illinois Tool Works Inc., Glenview, IL (US)

(72) Inventors: Gerit Vollmer, Linden (DE); Jan Müller, Würzburg (DE); Jürgen Kohler, Königslutter am Elm (DE)

(21) Appl. No.: 19/070,859

(22) Filed: Mar. 5, 2025

(30) Foreign Application Priority Data
Mar. 7, 2024 (EP) 24162114.3
Aug. 23, 2024 (EP) 24196195.2

(51) Int. Cl. B60R 16/02; F16L 3/06

(52) U.S. Cl. CPC B60R 16/0215; F16L 3/06

(57) ABSTRACT

Disclosed is a fastening apparatus for fastening a first strand-like or elongated component having an approximately circular cross-section to a second component, such as for fastening a cable or a cable harness to a carrier component of a vehicle body of a motor vehicle. The fastening apparatus includes a fastening body and a receiving body. The fastening body having a fastener for connecting the fastening apparatus to a second component, in particular a carrier component or a vehicle body of a motor vehicle. The receiving body forms a receiving portion having a receiving surface facing in the direction of a first component for receiving a first component. An adhesive means is arranged on the receiving surface of the receiving portion in order to connect a first strand-like component, in particular a cable or a cable harness, to the receiving body directly by via an adhesive.

### RELATED APPLICATIONS

The present application claims priority to European Patent Application Nos. EP 24162114.3, filed Mar. 7, 2024, and EP 24196195.2, filed Aug. 23, 2024, each entitled “Fastening Apparatus for Fastening a First Component to a Second Component, as well as a Method for Assembling Such a Fastening Apparatus,” the contents of which are hereby incorporated by reference.

### BACKGROUND

A cable harness is an often ready-made bundling of individual leads that transmit signals (information) or work currents (energy). The leads are routed as a cable harness and wrapped or held together by clamps, cable ties, twine, or hoses. Such cable harnesses can be connected to a fastening apparatus by means of cable ties, wherein this fastening apparatus is then connected to a vehicle body in order to secure the harness. In addition, it can also be provided that a cable harness is connected to a fastening apparatus by means of tape, wherein the fastening apparatus is connected to a vehicle body in order to secure the cable harness. Despite advancements to date, a need exists for a fastening apparatus for fastening a first strand-like component that is simple and safe and reliable in operation.

### SUMMARY

The present disclosure relates generally to a fastening apparatus, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a schematic, perspective view of a fastening apparatus according to the disclosure.

FIG. 2 illustrates a schematic, perspective view of the fastening apparatus according to the disclosure with a first component fastened thereto.

FIG. 3 illustrates a schematic, laterally cut view of the fastening apparatus of the disclosure with a first component having a larger diameter fastened thereto.

FIG. 4 illustrates a schematic, laterally cut view of the fastening apparatus according to the disclosure with a first component having a smaller diameter fastened thereto.

FIG. 5 illustrates a schematic side view of an assembly apparatus according to the disclosure for connecting a fastening apparatus according to the disclosure to a strand-like component in a home position.

FIG. 6 illustrates a schematic side view of the assembly apparatus according to the disclosure with a fastening apparatus.

FIG. 7 illustrates a schematic perspective view of a swage head of the assembly apparatus immediately prior to receiving the fastening apparatus according to the disclosure.

FIG. 8 illustrates a schematic perspective view of the swage head while receiving the fastening apparatus according to the disclosure.

FIG. 9 illustrates a schematic perspective view of the assembly apparatus with the fastening apparatus received.

FIG. 10 illustrates a schematic perspective view of the assembly apparatus with the fastening apparatus received, rotated by 60°, prior to receiving a strand-like component.

FIG. 11 illustrates a schematic perspective view of the assembly apparatus with the fastening apparatus received, while receiving a strand-like component.

FIG. 12 illustrates a further schematic perspective view of the assembly apparatus with the fastening apparatus received, rotated by a further 60°, before receiving a strand-like component.

FIG. 13 illustrates a schematic side view of the illustration from FIG. 12.

FIG. 14 illustrates a further schematic side view of a swage head of the assembly apparatus prior to connecting to a strand-like component.

FIG. 15 illustrates a schematic detail view of the swage head while connecting the fastening apparatus to the strand-like component.

FIG. 16 illustrates a schematic detail view of the swage head upon release from the fastening apparatus and the strand-like component connected thereto.

FIG. 17 illustrates a schematic side view of the strand-like component with the fastening apparatus connected thereto in a state having been released by the swage head.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a fastening apparatus for fastening a first strand-like component having an approximately circular cross-section to a second component, in particular for fastening a cable or a cable harness to a carrier component of a vehicle body of a motor vehicle, as well as to a method for assembling such a fastening apparatus. One problem addressed by the present disclosure is to provide a fastening apparatus for fastening a first strand-like component having an approximately circular cross-section to a second component, in particular for fastening a cable or a cable harness to a carrier component or a vehicle body of a motor vehicle, as well as a method for its assembly, which are simple and safe and reliable in operation.

A further problem addressed by the present disclosure is to provide a fastening apparatus as well as a method for producing such a fastening apparatus that allow a first component to be easily and quickly assembled onto a second component. In addition, problem addressed by the present disclosure is to form a fastening apparatus for fastening a first component to a second component, as well as a method for assembling such a fastening apparatus, which represents an alternative to known fastening apparatuses and methods.

According to the disclosure, a fastening apparatus for fastening a first strand-like or elongated component having an approximately circular cross-section to a second component, in particular for fastening a cable or a cable harness to a carrier component of a vehicle body of a motor vehicle, is to be provided. This fastening apparatus comprises: a fastening body having a fastener for connecting the fastening apparatus to a second component, in particular a carrier component or a vehicle body of a motor vehicle, and a receiving body, wherein the receiving body forms a receiving portion having a receiving surface facing in the direction of a first component for receiving a first component, and wherein an adhesive means is arranged on the receiving surface of the receiving portion in order to connect a first strand-like component, in particular a cable or a cable harness, to the receiving body directly by via an adhesive.

In the context of the present disclosure, a strand-like or elongated component having an approximately circular cross-section is understood in particular to be a cable harness for a motor vehicle. However, the fastening apparatus can also be configured in order to fasten pipes or lines or the like. Thus, the elongated component can be one or more cables or wires arranged in hoses or wrapped with adhesive tape.

The fastening apparatus according to the disclosure is configured as a single part or as a single assembly, which can be provided immediately upon assembly of first components or cable harnesses in order to fasten them to a vehicle body.

In the context of the present disclosure, the fastening apparatus can nonetheless be formed from a plurality of components, which are however assembled in such a way or form a unit or assembly such that no further connector, in particular adhesive means, are necessary in order to fasten a first component to a second component. This means that the fastening apparatus according to the disclosure is free of additional fastener, such as adhesive tape or cable ties, or does not comprise any further separate fastener for connecting a first component, in particular a cable harness, to the fastening apparatus.

Accordingly, the fastening apparatus can be provided as a single component or as a single assembly, so that a first component can be immediately fastened to a second component without the need for further technical means. Therefore, no further adhesive or connector for connecting the first component or a cable harness to the fastening apparatus need be provided.

Furthermore, the present disclosure is wherein the fastening apparatus can be produced entirely as a single component or as an assembly, and in particular automatically.

Thus, the present disclosure is wherein a first component is immediately and directly connectable to the fastening apparatus in a single working step and does not first have to be first arranged on the fastening apparatus and then, in a second step, a fastening of this first component must be carried out on the fastening apparatus. In this way, the fastening apparatus according to the disclosure can be assembled in a simple, secure, and reliable manner.

The fastening apparatus additionally represents an alternative to fastening apparatuses known from the prior art.

The receiving portion can extend in a longitudinal direction corresponding to an axial direction of a first component to be received, and is formed in an approximately trench-shaped (or C-shaped) manner in cross-section.

By a predetermined extension in the longitudinal direction, a retaining force between the fastening apparatus and the first component is increased by means of a larger receiving surface.

The receiving portion can have a length of at least 2 cm or 4 cm or 5 cm or 6 cm or 7 cm, respectively. The receiving portion can have a length of maximum 8 cm or 10 cm or 12 cm or 15 cm, respectively.

Due to the approximately trench-shaped configuration of the receiving portion in cross-section, it is adaptable to an outer geometry of a first component to be received, or the receiving surface between the first component and the fastening apparatus is also increased, because a more laminar abutment of the receiving portion on a first component is possible.

The receiving portion can be a universal receiving portion for receiving strand-like components having different diameters, and wherein the universal receiving portion comprises a central, trench-shaped first receiving portion having a first radius and a trench-shaped second receiving portion having a second radius which is greater than the radius of the first receiving portion, wherein a trench-shaped sub-section of the second receiving portion is molded onto the two longitudinally extending edges of the first trench-shaped receiving portion, respectively, wherein these two sub-sections form the second receiving portion.

By providing a universal receiving portion having at least a first and a second receiving portion, only a single fastening apparatus is still necessary in order to arrange first components, in particular cable harnesses having different diameters, by means of a single fastening apparatus on a second component, in particular a carrier component or a body of a motor vehicle.

Due to the fact that a single fastening apparatus can be provided for cable harnesses of varying diameters, costs is reduced, because only a single type of fastening apparatus need be provided. Furthermore, the universal receiving portion can also comprise three or four or more receiving portions by a corresponding segmentation or structuring of the receiving portion of the fastening apparatus with different radii and different receiving portions.

The fastening body and the receiving body can be integrally connected to one another or can form a single component. Such a fastening apparatus is accordingly easy to produce. Such a fastening apparatus is in particular also particularly simple in construction.

Alternatively, the fastening body and the receiving body can be releasably, in particular re-releasably, connected to one another by means of a connector and thus have a modular structure, i.e., form two separate components.

A two-piece structure as an assembly facilitates a quick exchange and allows for a more flexible disassembly during repairs or maintenance. In addition, different fastener can be provided on the fastening body and/or different receiving portions can be provided on the fastening body, which also allows for a high degree of flexibility in the use of the fastening apparatus according to the disclosure. Latching means, clip connections, screw connections, or rivet connections can be provided as connector between the fastening body and the receiving body.

The receiving portion can be configured so as to be flexible in the longitudinal direction.

The receiving portion can additionally and/or alternatively comprise film hinges extending orthogonally to the longitudinal direction.

On its lateral edge regions, the receiving body can comprise recesses that additionally and/or alternatively extend orthogonally to the longitudinal direction.

In this way, the receiving portion is segmented and/or flexibly configured in the longitudinal direction in such a way that it can be adapted to a curvature in the axial direction of a first receiving component.

The larger connecting surface between the receiving portion and a first component to be fastened provides a larger surface area covered with adhesive means, so that first components, in particular a cable harness, can be retained with a higher retaining force.

In addition, the risk that a component to be fastened becomes detached from the receiving portion by a corresponding flexure, for example during the assembly of a cable harness or during operation of the vehicle, is avoided, so that no damage to the adhesive connection between the receiving portion and the first component can be caused by flexure or by corresponding radii.

The fastening body can be approximately centrally connected to the receiving body in such a way that the fastening apparatus is approximately T-shaped and in such a way that the receiving surface of the receiving body and a fastening surface of the fastening body face in opposite directions, i.e., diametrically opposed to one another.

The adhesive means can be for, for example, a pressure-sensitive adhesive (PSA), a double-sided adhesive tape, a UV adhesive, a superglue (cyanoacrylate), or a hot melt glue.

In this case, a retaining force of the adhesive connection of up to 250 N can be achieved. At higher forces, the adhesive connection does not yield, rather the tear strength of the adhesive tape is achieved.

The fastener can be a latching device or a screwing means or an adhesive means.

Furthermore, according to the present disclosure, a method is provided for fastening a first strand-like or elongated component having an approximately circular cross-section to a second component, in particular for fastening a cable or a cable harness to a carrier component of a motor vehicle with a fastening apparatus as described above. This method comprises the following steps: adhering a first component to a receiving surface of a receiving portion of a receiving body of the fastening apparatus, and fastening a fastening body of the fastening apparatus to a second component, in particular using a corresponding fastener.

The advantages of the method according to the disclosure correspond largely to the advantages described above of the fastening apparatus according to the disclosure.

In particular, an approximately cross-section is understood in particular to be a cross-section of a cable harness, wherein, in the case of a corresponding wrapping of two or more cables by means of an adhesive tape or a hose or a heat-shrunk tube, crimped or not exactly circular cross-sections can result, which are nevertheless referred to as “approximately circular” in the context of the present disclosure.

In addition, according to the present disclosure, a method for producing a fastening apparatus as described above is provided. This method comprises the following steps: producing a fastening body and a receiving body from a plastic by means of a 1-component injection molding process, and applying, in particular automatically applying, an adhesive means onto a receiving surface of a receiving portion of the receiving body.

The advantages of the method according to the disclosure for producing the fastening apparatus have already been described above on the basis of the fastening apparatus according to the disclosure. This method is nonetheless characterized in particular in that a fastening apparatus can be produced in advance or in one or more work steps as a single component or as a single assembly together with adhesive means for connecting the fastening apparatus to a first component, such that a separate adhesive means need not be used later in the assembly of a cable harness, where a first component must then first be arranged in a receiving portion and then subsequently connected to the receiving portion by means of a separate adhesive means.

In the following, further technical features of the fastening apparatus according to the disclosure are described in greater detail.

With the fastening apparatus according to the disclosure, a fastening apparatus for fastening strand-like first components to a second component, which can be fully automated, is provided for the first time, and for the final connection of the strand-like first component to the fastening apparatus, neither an adhesive tape nor a cable tie is required.

According to the disclosure, the strand-like component can be glued directly onto the receiving portion of the fastening apparatus.

The synergistic effect here also results in the fact that strand-like components having different diameters or different cable harness diameters no longer pose a problem, because the entire circumference of the strand-like component does not need to be wrapped.

In particular, a hot melt adhesive is provided as the adhesive means.

Necessary contact pressure can be applied to a robotic device by a special application tool.

Alternatively, a UV adhesive or a superglue could also be provided as the adhesive means. The advantage of hot melt adhesive, however, is that it allows for high temperature resistance, high hydrolysis resistance, rapid initial adhesion, resistance to vibration and chemicals, and high retaining forces.

Often, when assembling cable harnesses, it is required that they be connected by winding the strand-like component in a fully circumferential manner together with the fastening apparatus. However, this requires an increased amount of time during assembly.

Furthermore, the method according to the disclosure for connecting a strand-like component, in particular a cable or a cable harness, to a fastening apparatus, can comprise the following steps: receiving the fastening apparatus by means of an assembly apparatus, and connecting the fastening apparatus to the strand-like component by forming an adhesive connection between the strand-like component and the receiving body of the fastening apparatus.

The inventors of the present disclosure have found that, with the method according to the disclosure, assembly is possible without retaining bands or a corresponding pre-assembly method. This allows for an extremely short cycle time.

Furthermore, the method for connecting a strand-like component, in particular a cable or a cable harness, to a fastening apparatus, can comprise in detail the following steps: receiving the fastening apparatus by means of the assembly apparatus.

In particular, removing the fastening apparatus from the processing apparatus by means of the assembly apparatus, which comprises a guide device configured so as to be approximately C-shaped and a swage head connected thereto.

The guide device can be movably configured and the swage head can be fixedly configured. Alternatively, the guide device can be fixedly configured and the swage head can be movably configured.

The assembly apparatus can be configured as a robot.

To remove a fastening apparatus from the processing apparatus by means of the assembly apparatus configured as a robot, the swage head can be moved to a removal position in the region of the processing apparatus in order to remove the fastening apparatus from the processing apparatus.

In this case, it can be provided that the swage head comprises a suction cup. The swage head then travels into the region of the processing apparatus and receives the fastening apparatus.

The reception can be carried out in particular by means of respective suction cups of the swage head, which suction onto correspondingly configured, preferably plate-shaped, suction surfaces of the processing apparatus in order to receive the fastening apparatus by means of the swage head.

The processing apparatus can comprise a retaining apparatus, in particular a gripper, for fixing the fastening apparatus during processing, in particular during cleaning and application of adhesive means.

This retaining means (or gripper) is opened or releases the fastening apparatus so that it can be removed from the fastening apparatus by the assembly apparatus.

Optionally, the gripper can extend out of the processing apparatus, for example downwardly, in such a way that the assembly apparatus can remove the processing apparatus.

Then, the swage head can be rotated by 180°.

The robot then travels with the swage head out of the processing apparatus or rotary table.

The robot can now be positioned such that a strand-like component can be arranged in or threaded into a receiving space of the C-shaped-shaped guide device and thus takes a threading position.

The swage head of the robot is then positioned either by movement of the swage head and/or by movement of the guide device in such a way that a strand-like component is arranged in the region of a retaining element of the swage head.

The swage head then rotates in a servo-controlled manner by a predetermined angular range along the guide device, for example up to 180° or up to 60°, such that the retaining element is arranged in a vertical direction below the strand-like component and the swage head is arranged in a vertical direction above the strand-like component.

The retaining element then travels until it contacts the strand-like component.

Subsequently, the suction device moves the fastening apparatus to the strand-like component so that it is pressed against the retaining element.

The adhesive connection between the strand-like component and the receiving body of the fastening apparatus can now be formed.

Then, the swage head can be released from the fastening apparatus.

The robot can subsequently remove the swage head from the strand-like component and the fastening apparatus connected thereto.

The strand-like component can then be connected to a carrier component via the fastening apparatus connected thereto.

The method described above for fastening a first strand-like component having an approximately circular cross-section to a second component, in particular for fastening a cable or a cable harness to a carrier component of a motor vehicle, thus comprises the following additional steps: feeding an adhesive means to a receiving surface via an adhesive supply channel that opens into the receiving surface, and connecting the strand-like first component to the receiving surface of the first receiving portion via the adhesive means.

Furthermore, a method is provided, in particular a final assembly method, for fastening a fastening apparatus which has a first strand-like component, in particular a cable or a cable harness, connected thereto, to a carrier component of a motor vehicle, having a fastening apparatus, comprising the following steps: fastening a fastening body of the fastening apparatus to a second component.

In addition, according to the present disclosure, a method of production of the fastening apparatus according to the present disclosure can comprise the following steps: optionally conveying a fastening apparatus to a processing apparatus, in particular a rotary table, cleaning, in particular plasma-cleaning, at least one receiving surface of the receiving body of the fastening apparatus, and applying adhesive means to a receiving surface of the receiving surface of the receiving body.

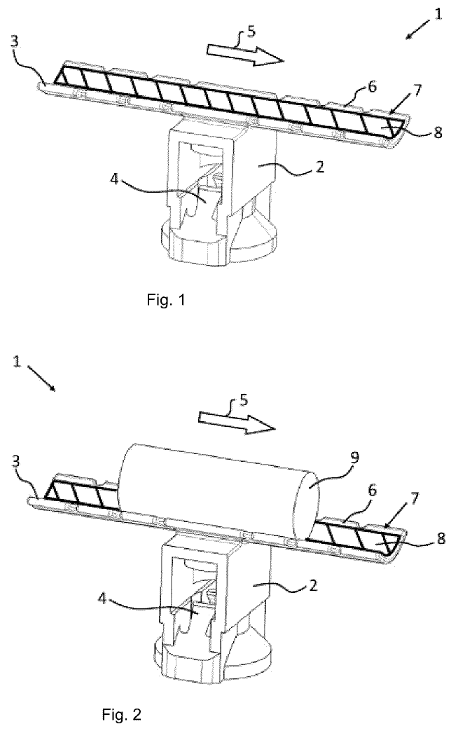

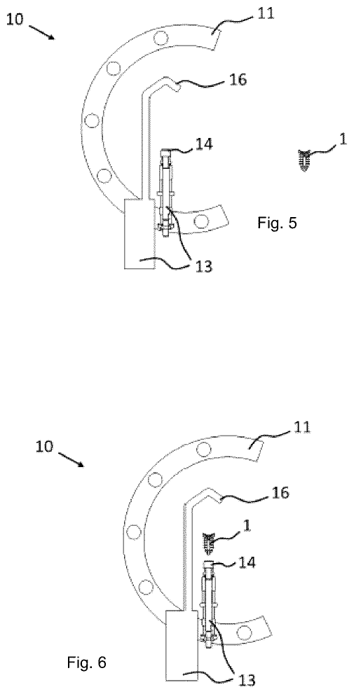

A fastening apparatus 1 for fastening a first strand-like or elongated component 9 having an approximately circular cross-section to a second component, in particular for fastening a cable or a cable harness to a carrier component or a vehicle body of a motor vehicle, comprises a fastening body 2 and a receiving body 3 (FIGS. 1 through 5).

The fastening apparatus 1 can be approximately T-shaped. However, the fastening apparatus 1 can also have another suitable shape, such as the shape described by way of example using the only exemplary aspect.

The fastening body 2 comprises a fastener 4 at its free end. In the present exemplary aspect, the fastener 4 is a bolt fastener (stud retainer).

However, the fastener 4 can also be configured as another fastener, which is not configured for fastening the fastening apparatus 1 to a bolt of a carrier component, for example a corresponding latching device, a screw connection, a rivet connection, or another suitable connection.

Preferably, the following fastener are provided: blind-hole fastening with metal clip; fastening on an edge with an edge clip; clip solution into a hole (e.g., with pinetree foot); fastening to bolts with a bolt receptacle (see figures); and/or a corresponding retaining force is approx. 150 N.

According to this exemplary aspect, the receiving body 3 is integrally connected to the fastening body 2, so that they are formed as a single component. The fastening body 2 and the receiving body 3 can in particular be made from a plastic by means of a 1-component injection molding process.

According to an alternative aspect (not shown), the fastening body 2 and the receiving body 3 are configured as two separate or individual components, which can be connected to one another by means of a corresponding connector.

A locking means or a clip connection or a screw connection or the like can preferably be provided as the connector.

The fastening body 2 comprises an elongated receiving portion 6 extending in a longitudinal direction 5.

The longitudinal direction 5 corresponds to an axial direction of a first strand-like or elongated component 9 or a cable harness that is to be received.

In the present exemplary aspect, the receiving portion 6 is approximately trench-shaped and/or C-shaped in cross-section orthogonally to the longitudinal direction 5.

A surface of the receiving portion 6 facing away from the free end of the fastening body 2 and the fastener 4, respectively, is referred to as the receiving surface 7. The receiving surface 7 thus faces in the direction of a first component or cable harness to be received.

On the receiving surface 7, an adhesive means 8 is preferably applied in a full-surface or nearly full-surface manner.

In the context of the present disclosure, the terms “full-surface” and “nearly full-surface” are understood to mean that approximately 70% or approximately 80% or approximately 90% or approximately 95% or approximately 100% of the receiving surface 7 is covered with an adhesive means 8, i.e., the adhesive means 8 is arranged in such a way on the receiving surface.

The fastening body 2 and the receiving body 3 can be formed from a plastic, such as PA66, PA6, or POM. Preferably, PA66 is provided.

The adhesive means 8 can be for, for example, a pressure-sensitive adhesive (PSA), a double-sided adhesive tape, a UV adhesive, a superglue (cyanoacrylate), or a hot melt glue.

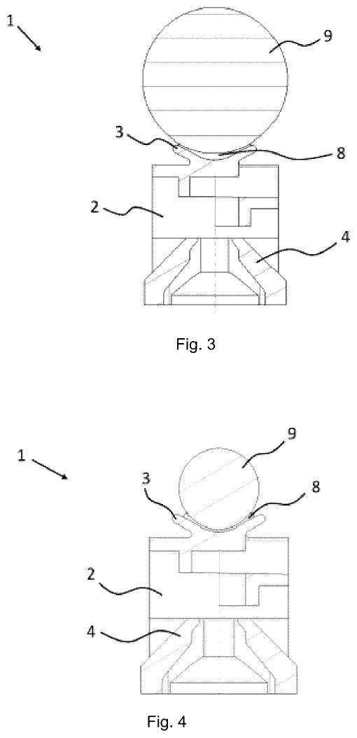

The receiving portion 6 can be configured so as to receive strand-like first components 9 having different diameters (FIGS. 3 and 4).

According to a further development of the fastening apparatus according to the disclosure (not shown), the receiving portion 6 can be a universal receiving portion for receiving strand-like first components 9 having different diameters (not shown).

It is then provided that the universal receiving portion comprises a central, trench-shaped first receiving portion 6 having a first radius. On lateral edges of this first receiving portion 6, which extend in the longitudinal direction 5, two sub-sections, which are also approximately trench-shaped, are respectively molded, forming the second receiving portion 6.

It could also be provided here that, in the same way as the second receiving section 6 connects to the first receiving section 6, further third or fourth receiving sections are also provided.

The two sub-sections then form the second receiving portion 6 which has a larger radius than the first receiving portion 6.

In particular, the receiving portion 6 is configured so as to be flexible in the longitudinal direction 5.

According to the present exemplary aspect, the free edges of the receiving portion 6 extending in the longitudinal direction 5 comprise recesses or notches extending orthogonally to the longitudinal direction 5, which segment the receiving portion 6 such that it is configured so as to be flexible in the longitudinal direction 5.

Additionally and/or alternatively, film hinges extending orthogonally to the longitudinal direction 5 can also be provided in the receiving section 6.

Furthermore, according to the present disclosure, a method is provided for fastening a first strand-like or elongated component 9 having an approximately circular cross-section to a second component, in particular for fastening a cable or a cable harness to a carrier component of a motor vehicle with a fastening apparatus 1 as described above. This method comprises the following steps: adhering a first component 9 to a receiving surface 7 of a receiving portion 6 of a receiving body 3 of the fastening apparatus 1, and fastening a fastening body 2 of the fastening apparatus 1 to a second component, in particular using a corresponding fastener.

In particular, according to the present disclosure, a method for producing a fastening apparatus 1 as described above is provided. This method comprises the following steps: producing a fastening body 2 and a receiving body 3 from a plastic by means of a 1-component injection molding process, and applying, in particular automatically applying, an adhesive means 8 onto a receiving surface 7 of a receiving portion 6 of the receiving body 3.

Furthermore, according to the disclosure, a method of manufacturing the fastening apparatus according to the disclosure is provided, comprising the steps of: optionally conveying a fastening apparatus to a processing apparatus, in particular a rotary table, cleaning, in particular plasma-cleaning, at least one receiving surface of the receiving body of the fastening apparatus, and applying adhesive means to a receiving surface of the receiving surface of the receiving body.

Furthermore, the method for connecting a strand-like component, in particular a cable or a cable harness, to a fastening apparatus, comprises in detail the following steps: receiving the fastening apparatus by means of the assembly apparatus 10.

In particular, removing the fastening apparatus from the processing apparatus (not shown) by means of the assembly apparatus 10, which comprises a guide device 11 configured so as to be approximately C-shaped and a swage head connected thereto.

The guide device 11 can be movably configured and the swage head can be fixedly configured. Alternatively, the guide device 11 can be fixedly configured and the swage head can be movably configured.

The assembly apparatus 10 can be configured as a robot.

To remove a fastening apparatus from the processing apparatus by means of the assembly apparatus 10 configured as a robot, the swage head is moved to a removal position in the region of the processing apparatus in order to remove the fastening apparatus from the processing apparatus.

It is provided in this case that the swage head comprises a suction cup 14 or other suitable receiving means. The swage head then travels into the region of the processing apparatus and receives the fastening apparatus.

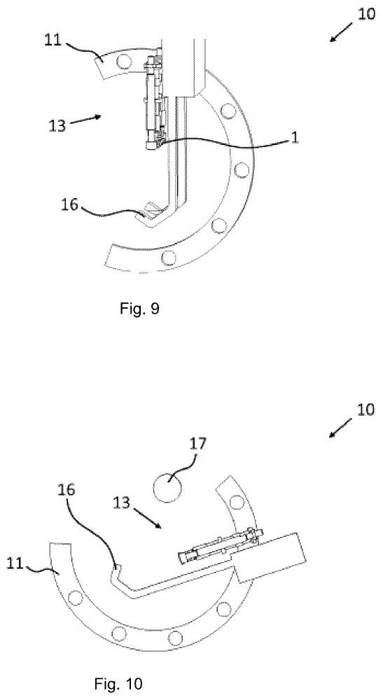

The reception is carried out in particular by means of respective suction cups of the swage head 13, which suction onto correspondingly configured, preferably plate-shaped, suction surfaces 15 of the processing apparatus in order to receive the fastening apparatus by means of the swage head 13 (FIGS. 8 and 9).

The processing apparatus comprises a retaining apparatus, in particular a gripper (not shown), for fixing the fastening apparatus during processing, in particular during cleaning and application of adhesive means.

This retaining means (or gripper) is opened or releases the fastening apparatus so that it can be removed from the fastening apparatus by the assembly apparatus 10.

Optionally, the gripper can extend out of the processing apparatus, for example downwardly, in such a way that the assembly apparatus 10 can remove the processing apparatus.

Then, the swage head 13 is rotated by 180°.

The robot then travels with the swage head 13 out of the processing apparatus or rotary table (not shown).

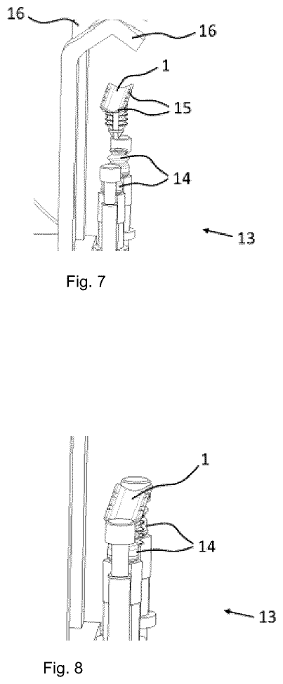

The assembly apparatus 10 or robot is now positioned such that a strand-like component 17 can be arranged in or threaded into a receiving space of the C-shaped-shaped guide device 11 and thus takes a threading position (FIG. 6).

The swage head of the robot is then positioned either by movement of the swage head 13 and/or by movement of the guide device 11 in such a way that a strand-like component 17 is arranged in the region of a retaining element of the swage head (FIGS. 7, 8, and 9).

The swage head 13 then rotates in a servo-controlled manner by a predetermined angular range along the guide device 11, for example up to 180° or up to 60°, such that the retaining element 16 is arranged in a vertical direction below the strand-like component 17 and the swage head 13 is arranged in a vertical direction above the strand-like component 17.

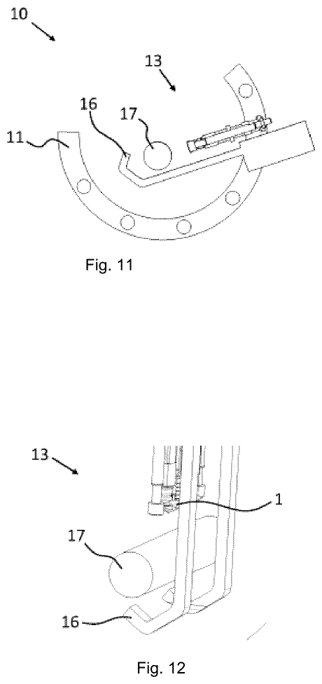

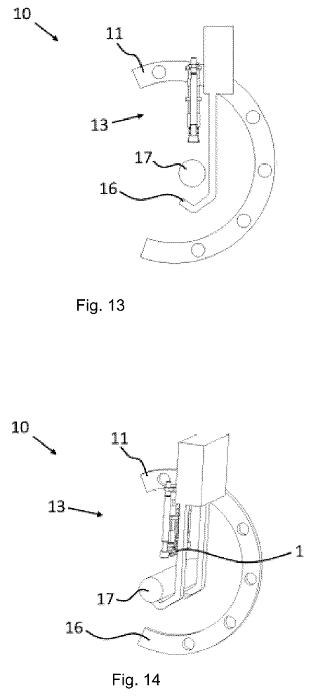

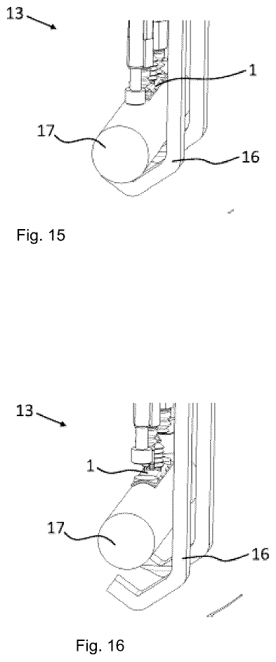

The retaining element 16 then travels until it contacts the strand-like component (FIGS. 11 to 16).

Subsequently, the suction device moves the fastening apparatus to the strand-like component 17 so that it is pressed against the retaining element 16.

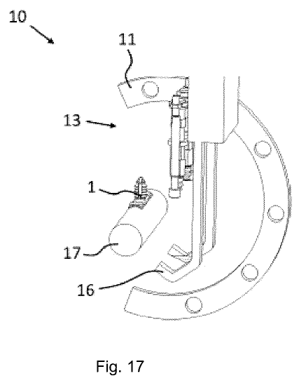

The adhesive connection between the strand-like component 17 and the receiving body 3 of the fastening apparatus 1 can then be formed (FIGS. 16 and 17).

Then, the swage head 13 is released from the fastening apparatus.

The robot subsequently removes the swage head 13 from the strand-like component and the fastening apparatus (FIG. 18) connected thereto.

The strand-like component 17 is then connected to a carrier component or second component (not shown) via the fastening apparatus 1 connected thereto.

Furthermore, a method is provided, in particular a final assembly method, for fastening a fastening apparatus which has a first strand-like component, in particular a cable or a cable harness, connected thereto, to a carrier component of a motor vehicle, having a fastening apparatus, comprising the following steps: fastening a fastening body of the fastening apparatus to a second component.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Fastening apparatus
2 Fastening body
3 Receiving body
4 Fastener
5 Longitudinal direction
6 Receiving portion
7 Receiving surface
8 Adhesive means
9 First component
10 Assembly apparatus
11 Guide device
13 Lug
14 Suction cup
15 Suction surfaces
16 Retaining element
17 Strand-like component

What is claimed is:

1. A fastening apparatus (1) for fastening a first strand-like component (9) having an approximately circular cross-section to a second component for fastening a cable or a cable harness to a carrier component of a motor vehicle, comprising
a fastening body (2) having a fastener (4) for connecting the fastening apparatus (1) to a second component, and
a receiving body (3), wherein the receiving body (3) forms a receiving portion (6) having a receiving surface (7) facing in a direction of a first component for receiving a first component, and
wherein an adhesive means (8) is or can be arranged on the receiving surface (7) of the receiving portion (6) in order to connect a first strand-like component (17) to the receiving body (3) by via an adhesive.

2. The fastening apparatus (1) according to claim 1, wherein the receiving portion (6) extends in a longitudinal direction (5) corresponding to an axial direction of a first component to be received, and is formed in an approximately trench-shaped (or C-shaped) manner in cross-section.

3. The fastening apparatus (1) according to claim 1, wherein the receiving portion (6) extends in a longitudinal direction (5) corresponding to an axial direction of a first component to be received, and is formed in an approximately trench-shaped manner in cross-section.

4. The fastening apparatus (1) according to claim 1, wherein the fastening body (2) and the receiving body (3) are integrally connected to one another.

5. The fastening apparatus (1) according to claim 2, wherein the receiving portion (6) is segmented and/or flexibly configured in the longitudinal direction (5) in such a way that it can be adapted to a curvature in the axial direction of a first receiving component (9).

6. The fastening apparatus (1) according to claim 1, wherein the adhesive means (8) is a pressure-sensitive adhesive (PSA), a double-sided adhesive tape, a UV adhesive, a superglue (cyanoacrylate), or a hot melt glue.

7. A method for connecting a strand-like component to a fastening apparatus, the method comprising:
receiving the fastening apparatus by means of an assembly apparatus (10), and
connecting the fastening apparatus to the strand-like component by forming an adhesive connection between the strand-like component (17) and the receiving body (3) of the fastening apparatus.

8. A method for connecting a strand-like component to a fastening apparatus, the method comprising:
receiving the fastening apparatus of claim 1 by means of an assembly apparatus (10);
connecting the fastening apparatus to the strand-like component by forming an adhesive connection between the strand-like component (17) and the receiving body (3) of the fastening apparatus; and
fastening a fastening body (2) of the fastening apparatus (1) to a second component.

9. A method for producing a fastening apparatus (1) according to claim 1, the method comprising:
producing a fastening body (2) and a receiving body (3) from a plastic by means of a 1-component injection molding process, and
applying an adhesive means (8) onto a receiving surface (7) of a receiving portion (6) of the receiving body (3).

10. The fastening apparatus (1) according to claim 1, wherein the fastening body (2) and the receiving body (3) are releasably connected to one another by means of a connector and thus have a modular structure.

11. The fastening apparatus (1) according to claim 1, wherein the second component is a carrier component of a motor vehicle.

12. The fastening apparatus (1) according to claim 5, wherein the receiving portion (6) is configured so as to be flexible in the longitudinal direction (5).

13. The fastening apparatus (1) according to claim 5, wherein the receiving portion (6) comprises film hinges extending orthogonally to the longitudinal direction (5).

14. The fastening apparatus (1) according to claim 5, wherein the receiving portion (6) has, on its lateral edge regions, recesses extending orthogonally to the longitudinal direction (5).
